(19) United States
(12) Patent Application Publication
(10) Pub. No.: US 2025/0056701 A1
(43) Pub. Date: Feb. 13, 2025

(54) CONTROL SYSTEM FOR SOLAR LAMP

(71) Applicants: Shenzhen Changdaneng Technology Co., Ltd., Shenzhen (CN); Shenzhen Parsonver Trading Co.,Ltd, Shenzhen (CN)

(72) Inventors: DONGMING ZHU, Shenzhen (CN); WEIKUN ZHENG, Shenzhen (CN)

(21) Appl. No.: 18/448,238

(22) Filed: Aug. 11, 2023

(51) Int. Cl. H05B 47/19; F21S 9/03; H02J 7/00; H02J 7/35

(52) U.S. Cl. CPC H05B 47/19; F21S 9/03; H02J 7/00032; H02J 7/0029; H02J 7/35

(57) ABSTRACT

Disclosed is a control system for a solar lamp, including a charging detection module, a main control module, a storage module, a wireless communication module, a lighting control module, and a power supply module, where a signal output end of the charging detection module is connected to a signal input end of the main control module, a signal output end of the main control module is connected to signal input ends of the storage module and the lighting control module respectively, the main control module interacts with the wireless communication module for signal transmission, and the power supply module is electrically to the charging detection module, the main control module, the storage module, the wireless communication module, and the lighting control module, respectively.

### TECHNICAL FIELD

The present disclosure relates to the technical field of solar lamps, in particular to a control system for a solar lamp.

### BACKGROUND

Due to heavy consumption of power, great impact on runtime capacity of products, poor transmission of signals and relatively serious delay, existing RGB synchronization function is mostly applied in lamps only powered by the mains supply at present, so as to guarantee the long-term runtime. When the lighting mode and state of a lamp are controlled through the infrared transmission function of a remote control unit, the lighting mode and state of the lamp beyond the receiving and transmission range of infrared ray will be out of control. Furthermore, due to poor capacity in receiving infrared signals, the lamp may suffer a delay in receiving the signals after the remote control unit sends a command to change the state, therefore, RGB synchronization function cannot be popularized and applied in the field of solar lamps.

### SUMMARY

An objective of the present disclosure is to provide a control system for a solar lamp.

In order to achieve the above objective, the present disclosure provides the following technical solution:

A control system for a solar lamp, including a charging detection module, a main control module, a storage module, a wireless communication module, a lighting control module, and a power supply module, where a signal output end of the charging detection module is connected to a signal input end of the main control module, a signal output end of the main control module is connected to signal input ends of the storage module and the lighting control module respectively, the main control module interacts with the wireless communication module for signal transmission, and the power supply module is electrically to the charging detection module, the main control module, the storage module, the wireless communication module, and the lighting control module, respectively.

Further, the charging detection module also includes a battery protection unit.

Further, the wireless communication module includes one of a 2.4G control unit or a GPS synchronization unit.

Further, the power supply module includes a voltage regulation unit.

Further, the control system further includes a sensing module, where a signal output end of the sensing module is connected to the signal input end of the main control module.

Further, the chip model of the battery protection unit is DW03A.

Further, the chip model of the voltage regulation unit is AS7133L.

Further, the chip model of the main control module is AS255-16A.

Further, the chip model of the 2.4G control unit is AS297W.

Further, the chip model of the storage module is BL24C02-RRRC.

Compared with the prior art, the present disclosure has the following beneficial effects:

A control system of a solar lamp is arranged through the cooperation of the charging detection module, the main control module, the storage module, the wireless communication module, the lighting control module, and the power supply module, and the communication mode of the wireless communication module realizes low power consumption, low latency and a wide range of signals, such that the control system can be better applied in the solar lamps and lanterns. At the same time, each control system is arranged and taken as a host, which substitutes the traditional solution that a remote control unit controls the host and realizes the purpose that devices are capable of controlling one other, thereby solving a chronic problem that the host is unable to be used normally due to damage of the remote control unit, so that the RGB synchronization function can be popularized and applied in the field of solar lamps.

### BRIEF DESCRIPTION OF DRAWINGS

FIG. 1 is a schematic structural diagram of a circuit of a control system for a solar lamp of the present disclosure;

FIG. 2 is a circuit diagram of a charging detection module for a control system for a solar lamp in FIG. 1 of the present disclosure;

FIG. 3 is a circuit diagram of a power supply module for a control system for a solar lamp in FIG. 1 of the present disclosure;

FIG. 4 is a circuit diagram of a main control module for a control system for a solar lamp in FIG. 1 of the present disclosure;

FIG. 5 is a circuit diagram of a storage module for a control system for a solar lamp in FIG. 1 of the present disclosure;

FIG. 6 is a circuit diagram of a wireless communication module for a control system for a solar lamp in FIG. 1 of the present disclosure; and

FIG. 7 is a circuit diagram of a lighting control module for a control system for a solar lamp in FIG. 1 of the present disclosure.

Reference numerals in the drawings: charging detection module 100, main control module 200, storage module 300, wireless communication module 400, lighting control module 500, and power supply module 600.

### DETAILED DESCRIPTION

In order to make the above objectives, features and advantages of the present disclosure more apparent and comprehensible, specific embodiments of the present disclosure will be described in detail below in conjunction with the accompanying drawings. Many specific details are set forth in the following description to facilitate thorough understanding of the present disclosure. However, the present disclosure may be implemented in many other ways different from those described herein, similar improvements may be made by those skilled in the art without departing from the connotation of the present disclosure, and therefore the present disclosure is not limited by the specific embodiments disclosed below.

It should be noted that when an element is considered to be “connected” to another element, the element may be directly connected to another element or there may be an intermediate element simultaneously. In contrast, when an element is referred to as “directly” connected to another element, there is no intermediate element.

Unless otherwise defined, all technical and scientific terms mentioned herein have the same meaning as commonly understood by those skilled in the technical field of the present disclosure. Terms mentioned in the description of the present disclosure are used only for the purpose of describing specific embodiments, and are not intended to limit the present disclosure. As mentioned herein, the term “and/or” includes any and all combinations of one or more relevant listed items.

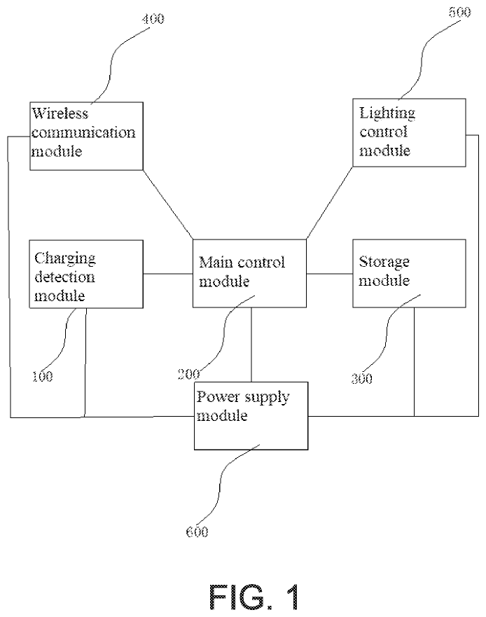

Referring to FIG. 1: a control system for a solar lamp, including a charging detection module 100, a main control module 200, a storage module 300, a wireless communication module 400, a lighting control module 500, and a power supply module 600, where a signal output end of the charging detection module 100 is connected to a signal input end of the main control module 200, a signal output end of the main control module 200 is connected to signal input ends of the storage module 300 and the lighting control module 500 respectively, the main control module 200 interacts with the wireless communication module 400 for signal transmission, and the power supply module 600 is electrically to the charging detection module 100, the main control module 200, the storage module 300, the wireless communication module 400, and the lighting control module 500, respectively.

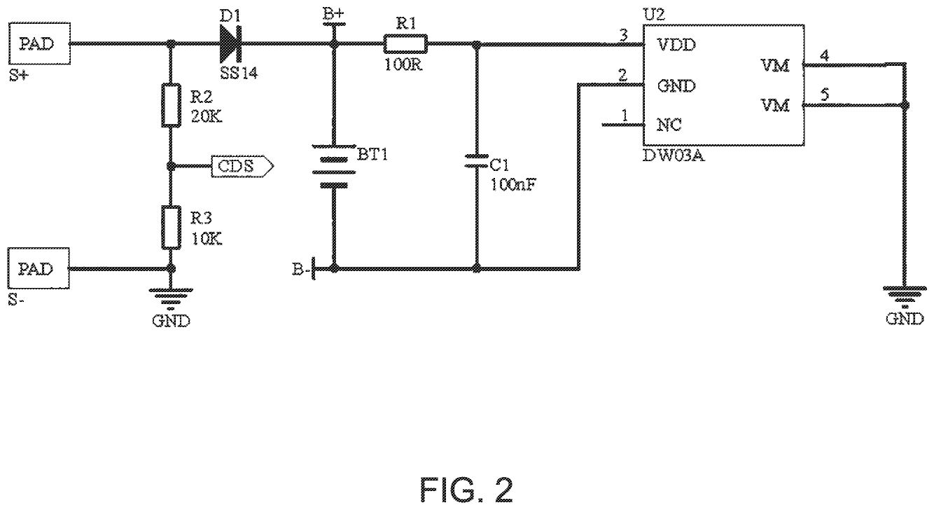

Referring to FIG. 2, further, the charging detection module 100 also includes a battery protection unit.

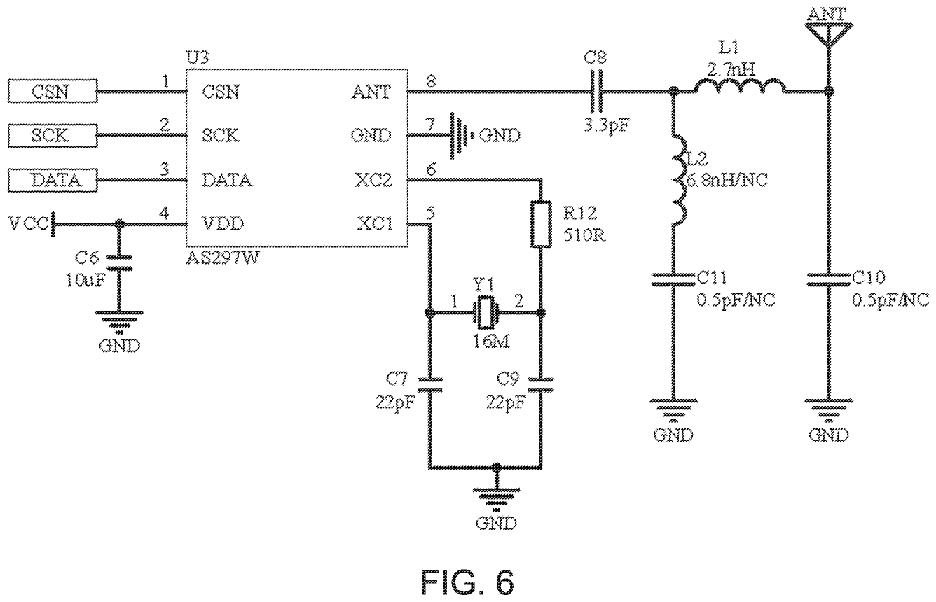

Referring to FIG. 6, further, the wireless communication module 400 includes one of a 2.4G control unit or a GPS synchronization unit.

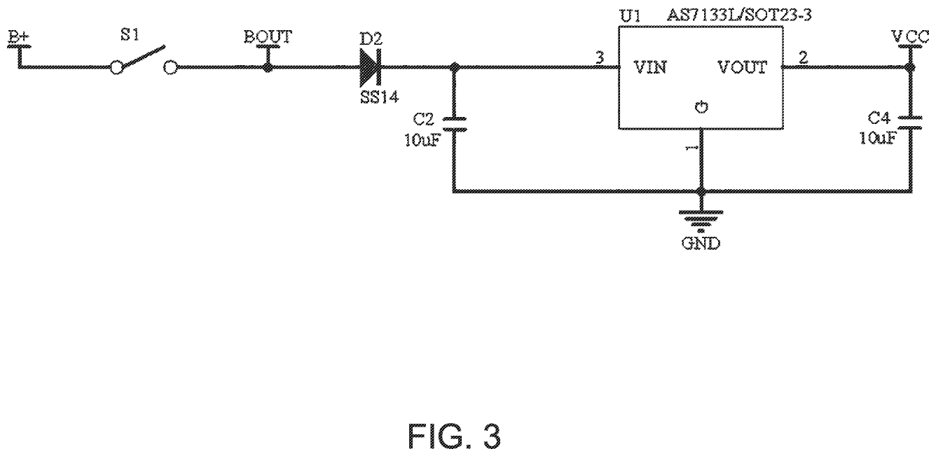

Referring to FIG. 3, further, the power supply module 600 includes a voltage regulation unit.

Further, the control system further includes a sensing module, where a signal output end of the sensing module is connected to the signal input end of the main control module.

Further, the chip model of the battery protection unit is DW03A.

Further, the chip model of the voltage regulation unit is AS7133L.

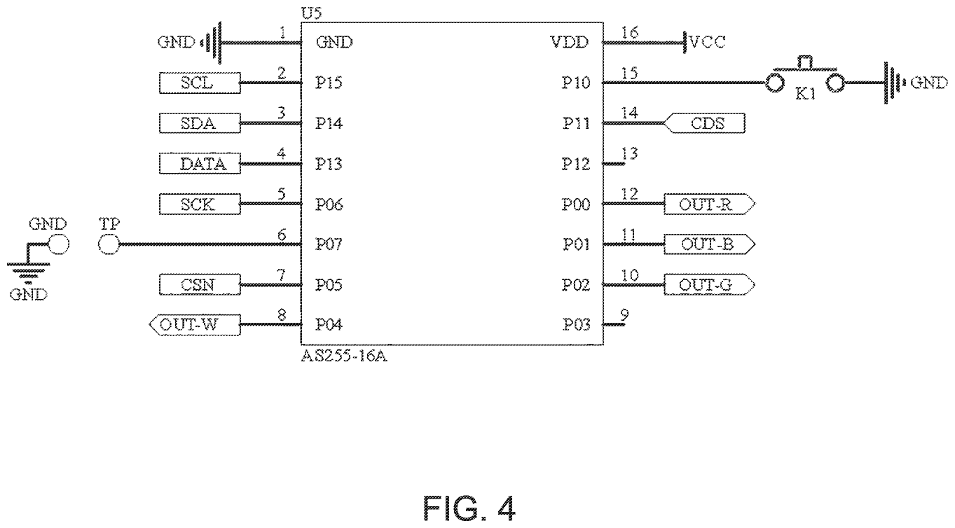

Referring to FIG. 4, further, the chip model of the main control module 200 is AS255-16A.

Further, the chip model of the 2.4G control unit is AS297W.

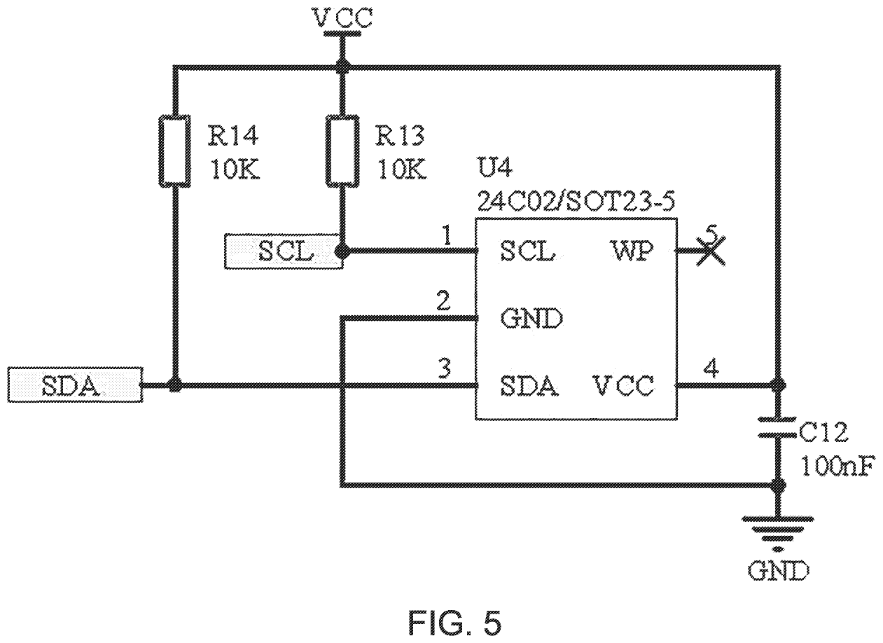

Referring to FIG. 5, further, the chip model of the storage module 300 is BL24C02-RRRC.

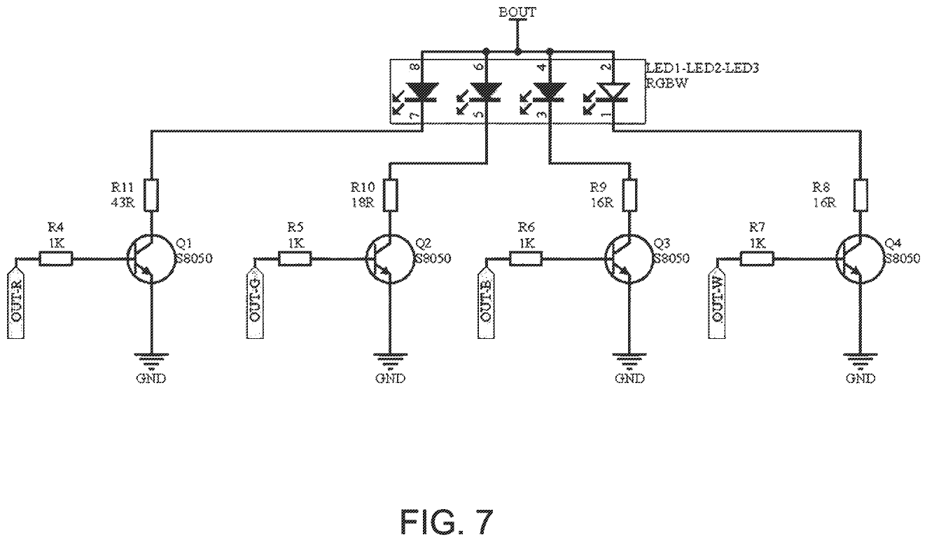

Referring to FIG. 7, the power supply module 600 supplies power to the charging detection module 100, the main control module 200, the storage module 300, the wireless communication module 400, and the lighting control module 500, respectively.

A pin CDS of the charging detection module 100 is connected to a pin P11 of the main control module 200, pins SDA and SCL of the storage module 300 are connected to pins P14 and P15 of the main control module 200, respectively, pins CSN, SCK and DATA of the wireless communication module 400 are connected to pins P05, P06 and P13 of the main control module 200, respectively, one end of R4 of the lighting control module 500 is connected to a pin P00 of the main control module 200, one end of R5 of the lighting control module 500 is connected to a pin P02 of the main control module 200, and one end of R6 of the lighting control module 500 is connected to a pin P01 of the main control module 200.

Charging detection module 100: the solar power supply voltage is divided by resistors R2 and R3 for CDS detection pin, and the main control module 200 detects the pin position and confirms the current light sensitivity, and charges a battery through a diode D1.

Battery protection unit: the battery protection unit carries out the charging and discharging protection of a lithium battery by the lithium protection IC DW03A, charging protection voltage: 4.3V, charging release voltage: 4.1V, discharging protection voltage: 2.4V, and discharging release voltage: 3.0V.

Power supply module 600: a diode D2 is configured to play a role in anti-reverse connection, thereby avoiding burning of the main control module 200 and other components due to reverse connection of the battery; and a voltage regulation chip AS7133L is configured to provide a stable voltage of 3.3V as the power supply of the main control module 200.

Main control module 200: the main control module 200 detects the button of a switch K1 through a pin P10, so as to achieve the effect of mode switching by detecting whether the button is pressed down, and detects whether it enters into the pairing code state by detecting whether a pin P07 is shorted to the ground.

Storage module 300: the storage module is configured to realize storage of the code value and mode of the network pairing code, as well as the operation of the power-failure memory function and ex-factory networking settings through the communication between Eeprom and the main control module 200.

Wireless communication module 400: the wireless communication module is configured to realize the signal transmission and reception of the networking synchronization function through the communication between the 2.4G control chip AS297W and the main control module 200, featuring low power consumption, short delay and wide range of signals.

Lighting control module 500: the lighting control module is configured to realize the light brightness control of each lamp bead through the PWM output port of the main control module 200, so as to achieve light color temperature effects under different brightness matching.

In such a way, a control system of a solar lamp is arranged through the cooperation of the charging detection module, the main control module, the storage module, the wireless communication module, the lighting control module, and the power supply module, and the communication mode of the wireless communication module 400 realizes low power consumption, low latency and a wide range of signals, such that the control system can be better applied in the solar lamps and lanterns. At the same time, each control system is arranged and taken as a host, which substitutes the traditional solution that a remote control unit controls the host and realizes the purpose that devices are capable of controlling one other, thereby solving a chronic problem that the host is unable to be used normally due to damage of the remote control unit, so that the RGB synchronization function can be popularized and applied in the field of solar lamps.

Further, the control system further includes a sensing module, where a signal output end of the sensing module is connected to the signal input end of the main control module.

In such a way, by introducing the sensing module, when a person is sensed to pass by the solar lamp, the lighting control module 500 is controlled by the main control module 200 to automatically change the lighting mode, which makes the use of solar lamps more interesting.

Various technical features of the embodiments mentioned above may be arbitrarily combined. In order to simplify the description, all possible combinations of the various features of the embodiments mentioned above are not described. However, if only the combinations of these technical features do not conflict, they should be considered to be within the scope of description of the present disclosure.

The embodiments mentioned above are merely several embodiments of the present disclosure, and are specifically described in details, but cannot be interpreted as limiting the scope of the patent for the present disclosure as a result. It shall be noted that for those of ordinarily skilled in the art, they may make several transformations and improvements on the premise without deviating from concepts of the present disclosure, these transformations and improvements should be considered to fall within the protection scope of the present disclosure. Hence, the protection scope of the patent for the present disclosure should be subject to the appended claims.

1. A control system for a solar lamp, comprising a solar lamp, a charging detection module, a main control module, a storage module, a wireless communication module, a lighting control module, and a power supply module,
wherein a signal output end of the charging detection module is connected to a signal input end of the main control module, a signal output end of the main control module is connected to signal input ends of the storage module and the lighting control module respectively,
the main control module interacts with the wireless communication module for signal transmission, and the power supply module is electrically connected to the charging detection module, the main control module, the storage module, the wireless communication module, and the lighting control module, respectively;
wherein the charging detection module further comprises a battery protection unit.

2. (canceled)

3. The control system for a solar lamp according to claim 1, wherein the wireless communication module comprises one of a 2.4G control unit or a GPS synchronization unit.

4. The control system for a solar lamp according to claim 1, wherein the power supply module comprises a voltage regulation unit.

5. The control system for a solar lamp according to claim 1, wherein the main control module comprises a sending module, and a signal output end of the sensing module is connected to the signal input end of the main control module.

6. The control system for a solar lamp according to claim 1, wherein the chip model of the battery protection unit is DW03A.

7. The control system for a solar lamp according to claim 4, wherein the chip model of the voltage regulation unit is AS7133L.

8. The control system for a solar lamp according to claim 1, wherein the chip model of the main control module is AS255-16A.

9. The control system for a solar lamp according to claim 3, wherein the chip model of the 2.40 control unit is AS297W.

10. The control system for a solar lamp according to claim 1, wherein the chip model of the storage module is BL24C02-RRRC.
